(19) United States
(12) Patent Application Publication
(10) Pub. No.: US 2025/0093486 A1
(43) Pub. Date: Mar. 20, 2025

(54) TRANSMITTER SELF-JAMMING ANALOG CANCELLATION

(71) Applicant: QUALCOMM Incorporated, San Diego, CA (US)

(72) Inventors: Chinmaya MISHRA, San Diego, CA (US); Chirag Dipak PATEL, San Diego, CA (US); Roberto RIMINI, San Diego, CA (US); Udara FERNANDO, San Diego, CA (US); Ahmad Bassil ZOUBI, San Diego, CA (US)

(21) Appl. No.: 18/471,153

(22) Filed: Sep. 20, 2023

(51) Int. Cl. G01S 13/42; G01S 13/02; G01S 13/524

(52) U.S. Cl. CPC G01S 13/42; G01S 13/524; G01S 2013/0245

(57) ABSTRACT

Certain aspects provide a method for object detection. The method generally includes: transmitting, via a first antenna, a transmit signal generated via a first transmit chain, the transmit signal being generated based on a mixer output signal; receiving a first receive signal via a first receive chain coupled to a second antenna, the first receive signal being associated with the transmit signal; generating, via a first phase shifter, a first phase-shifted signal based on an adjustment signal received via a signal path coupled to the first transmit chain, the adjustment signal being generated based on the mixer output signal; combining the first phase-shifted signal and the first receive signal to generated a combined receive signal, wherein a phase-shift setting of the first phase shifter is controlled based on at least one of a mutual coupling component or a phase noise of the combined receive signal.

### TECHNICAL FIELD

Certain aspects of the present disclosure generally relate to a device capable of object detection, and more particularly, to techniques for reducing effects of mutual coupling between antennas during object detection.

### BACKGROUND

Electronic devices include computing devices such as desktop computers, notebook computers, tablet computers, smartphones, wearable devices like a smartwatch, internet servers, and so forth. These various electronic devices provide information, entertainment, social interaction, security, safety, productivity, transportation, manufacturing, and other services to human users. An electronic device may be used to perform radio detection and ranging (RADAR) operations. For the RADAR operations, a signal may be transmitted to reflect off of an object. The reflection of the signal may be detected by a receiver, and a distance between the object and the electronic device may be determined based on the reflected signal (e.g., a frequency of the reflected signal).

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a method for wireless communication by a device. The method generally includes: transmitting a transmit signal via a first antenna; receiving a first receive signal via a second antenna and a second receive signal via a third antenna, the first receive signal and the second receive signal being associated with the transmit signal; generating a first phase-shifted signal via a first phase shifter based on the first receive signal, and a second phase-shifted signal via a second phase shifter based on the second receive signal; and combining the first phase-shifted receive signal and the second phase-shifted signal to generate a combined receive signal, wherein at least one of generating the first phase-shifted signal or generating the second phase-shifted signal comprises controlling a phase-shift setting of at least one of the first phase shifter or the second phase shifter based on at least one of a mutual coupling component or a phase noise of the combined receive signal.

Certain aspects of the present disclosure are directed towards a device capable of object detection. The device generally includes: a transmit chain configured to transmit a transmit signal via a first antenna; a first receive chain configured to receive a first receive signal via a second antenna; a second receive chain configured to receive a second receive signal via a third antenna, the first receive signal and the second receive signal being associated with the transmit signal, wherein: the first receive chain comprises a first phase shifter configured to generate a first phase-shifted signal based on the first receive signal, the second receive chain comprises a second phase shifter configured to generate a second phase-shifted signal based on the second receive signal; and the first phase-shifted receive signal and the second phase-shifted signal are combined to generate a combined receive signal; and a control unit configured to control a phase-shift setting of at least one of the first phase shifter or the second phase shifter based on at least one of a mutual coupling component or a phase noise of the combined receive signal.

Certain aspects of the present disclosure are directed towards an apparatus for wireless communication. The apparatus generally includes: means for transmitting a transmit signal; means for receiving a first receive signal and a second receive signal, the first receive signal and the second receive signal being associated with the transmit signal; means for generating a first phase-shifted signal via a first phase shifter based on the first receive signal, and a second phase-shifted signal via a second phase shifter based on the second receive signal; means for combining the first phase-shifted receive signal and the second phase-shifted signal to generate a combined receive signal; and means for controlling a phase-shift setting of at least one of the first phase shifter or the second phase shifter based on at least one of a mutual coupling component or a phase noise of the combined receive signal.

Certain aspects of the present disclosure are directed towards a method for object detection by a device. The method generally includes: transmitting, via a first antenna, a transmit signal generated via a first transmit chain of the device, the transmit signal being generated based on a mixer output signal; receiving a first receive signal via a first receive chain coupled to a second antenna of the device, the first receive signal being associated with the transmit signal; generating, via a first phase shifter of the device, a first phase-shifted signal based on an adjustment signal received via a signal path of the device coupled to the first transmit chain, the adjustment signal being generated based on the mixer output signal; combining the first phase-shifted signal and the first receive signal to generated a combined receive signal, wherein a phase-shift setting of the first phase shifter is controlled based on at least one of a mutual coupling component or a phase noise of the combined receive signal.

Certain aspects of the present disclosure are directed towards a device capable of object detection. The device generally includes: a first transmit chain configured to transmit, via a first antenna, a transmit signal, the transmit signal being generated based on a mixer output signal; a first receive chain coupled to a second antenna and configured to receive a first receive signal, the first receive signal being associated with the transmit signal; a first phase shifter configured to generate a first phase-shifted signal based on an adjustment signal received via a signal path of the device coupled to the first transmit chain, the adjustment signal being generated based on the mixer output signal, wherein the first phase-shifted signal and the first receive signal are combined to generated a combined receive signal; and a control unit configured to control a phase-shift setting of the first phase shifter based on at least one of a mutual coupling component or a phase noise of the combined receive signal.

Certain aspects of the present disclosure are directed towards an apparatus for object detection by a device. The apparatus generally includes: means for transmitting a transmit signal, the transmit signal being generated based on a mixer output signal; means for receiving a first receive signal, the first receive signal being associated with the transmit signal; means for generating a first phase-shifted signal based on an adjustment signal received via a signal path of the device, the adjustment signal being generated based on the mixer output signal, wherein the first phase-shifted signal and the first receive signal are combined to generate a combined receive signal; and means for controlling a phase-shift setting associated with the means for generating based on at least one of a mutual coupling component or a phase noise of the combined receive signal.

Certain aspects of the present disclosure are directed towards a method for object detection. The method generally includes: transmitting a transmit signal via a first transmit chain coupled to a first antenna; receiving, via a second antenna, a receive signal including at least a mutual coupling component; processing the receive signal at a first receive chain coupled to the second antenna to generate a processed receive signal; and using a signal from a chain other than the first receive chain to at least partially cancel the mutual coupling component of the processed receive signal using an on-chip signal path.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a wireless communications system with access points and user terminals, in which aspects of the present disclosure may be practiced.

FIG. 2 shows a block diagram of an access point and user terminals, in which aspects of the present disclosure may be practiced.

FIG. 3 is a block diagram of an example transceiver front end, in which aspects of the present disclosure may be practiced.

FIG. 4 illustrates a reflected echo from a target affected by transmitter self-jamming (mutual coupling) for a wireless communication circuit.

FIG. 5A illustrates a wireless communication circuit with multiple receive antennas and with adjustable phase shifters controlled with a feedback loop, in accordance with certain aspects of the present disclosure.

FIG. 5B illustrates a wireless communication circuit receiving horizontal and vertical polarization signals from a receive antenna with adjustable phase shifters for horizontal and vertical receive paths, in accordance with certain aspects of the present disclosure.

FIG. 5C illustrates different receive directions associated with a mutual coupling (MC) component and a reflection component of a receive signal, in accordance with certain aspects of the present disclosure.

FIG. 6 is a flow diagram illustrating example operations for wireless communication in accordance with certain aspects of the present disclosure.

FIGS. 7, 8, and 9 illustrate a wireless communication circuit having radio frequency integrated circuits (RFICs) with internal loopback paths and adjustable phase shifters, in accordance with certain aspects of the present disclosure.

FIG. 10 is a flow diagram illustrating example operations for wireless communication, in accordance with certain aspects of the present disclosure.

FIG. 11 is a flow diagram illustrating example operations for wireless communication, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure generally relate to techniques and apparatus for canceling (or at least reducing) effects of a mutual coupling (MC) component of a receive signal for a device capable of object detection (e.g., detection of presence of an object). The MC component may be due to MC between transmit and receive antennas, especially when transmitting and receiving using the same frequency band. In some aspects, a transmit signal may be transmitted via a transmit antenna while receiving via multiple receive antennas. The receive signals from each of the multiple receive antennas may have a MC component and a reflection component (e.g., based on reflection of the transmit signal from an object (also referred to herein as a target (TRGT)). In some aspects of the present disclosure, the receive signals may be phase-shifted via respective phase shifters. The phase-shifted signals may be combined to yield a combined receive signal. The setting of one or more of the phase shifters may be controlled to cancel (or at least reduce) the MC component of the combined receive signal. The combined receive signal may be used for radio detection and ranging (RADAR) operations (e.g., to detect the object based on the reflection of the transmit signal from the object).

In some aspects, a signal path of the device may be used to cancel (e.g., reduce) the effects of MC between antennas. For example, a transmit path may be used to transmit a signal based on a mixer output signal, while signal reception is performed via a receive path. An adjustment signal may be generated based on the mixer output signal. A phase-shifted signal may be generated based on the adjustment signal via a phase shifter. The phase-shifted signal may be combined with the receive signal to generate a combined receive signal. A phase-shift setting of the phase shifter may be controlled to cancel (or at least reduce) the MC component of the combined receive signal. The combined receive signal may be used to perform object detection, as described in more detail herein.

### Example Wireless Communications

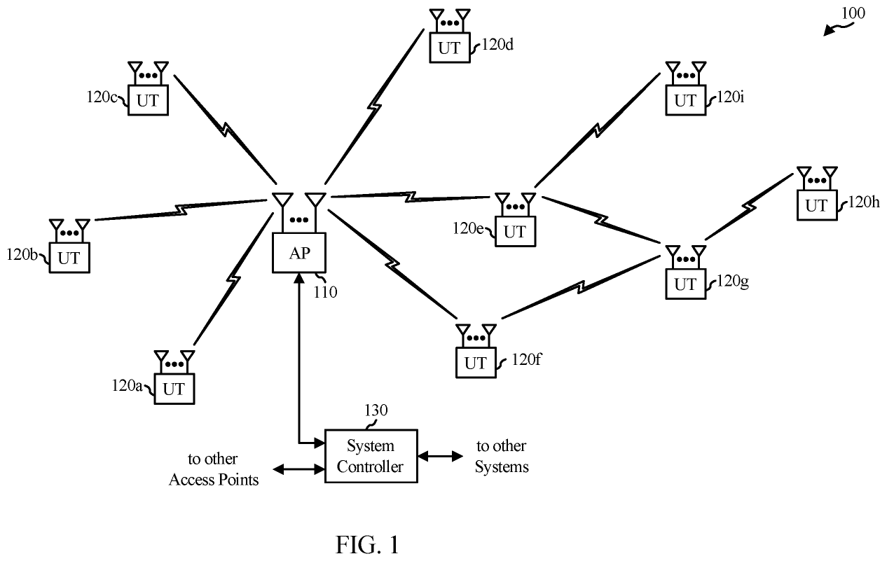

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), a next generation Node B (gNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

Wireless communications system 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nu of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≥1). The Nu selected user terminals can have the same or different number of antennas.

Wireless communications system 100 may be a time division duplex (TDD) system or a frequency division duplex (FDD) system. For a TDD system, the downlink and uplink share the same frequency band. For an FDD system, the downlink and uplink use different frequency bands. Wireless communications system 100 may also utilize a single carrier or multiple carriers for transmission. Each user terminal 120 may be equipped with a single antenna (e.g., to keep costs down) or multiple antennas (e.g., where the additional cost can be supported). In some aspects, the user terminal 120 or access point 110 may be used to perform RADAR operations using transmit and receive antennas while reducing effects of mutual coupling between the antennas, as described in more detail herein. While the devices in FIG. 1 are illustrated as being operational in a communications system 100, in some examples a device used to perform RADAR operations while reducing effects of mutual coupling as described herein may omit functionality to (wirelessly) communicate with a communications system or network. For example, the device may be a standalone RADAR device or configured to communicate with one or more other devices only directly.

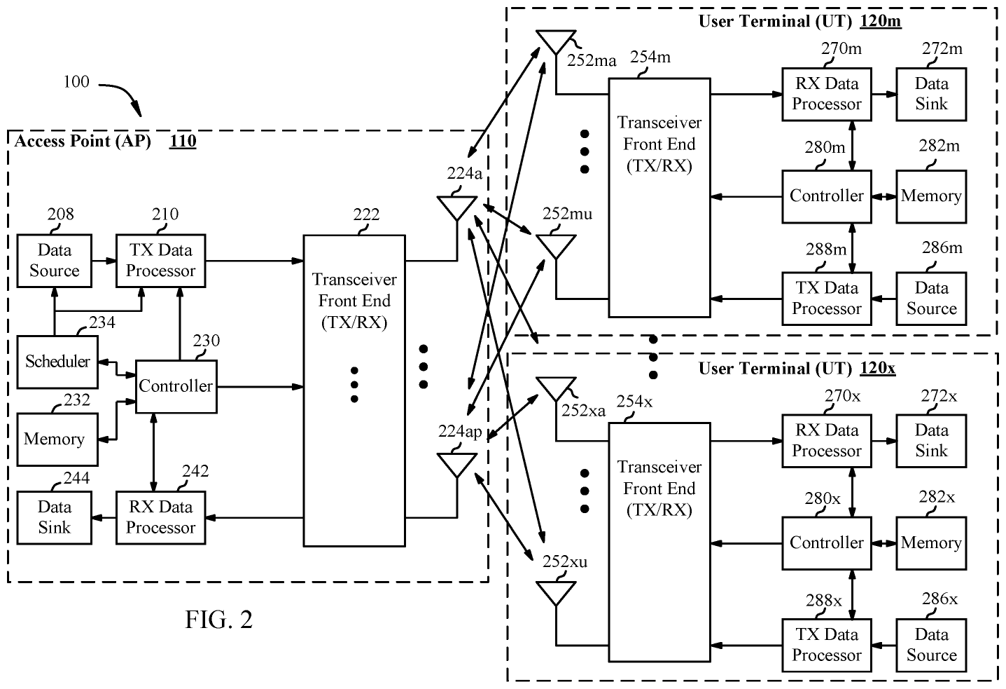

FIG. 2 shows a block diagram of access point 110 and two user terminals 120m and 120x in the wireless communications system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering, beamforming, or some other spatial processing technique may be used at the access point and/or user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one or more of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one or more of the N_{ut,m} antennas for transmit diversity via an RF switch, for example. The controller 280 may control the routing within the transceiver front end 254. Memory 282 may store data and program codes for the user terminal 120 and may interface with the controller 280.

A number Nᵤₚ of user terminals 120 may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one or more of the antennas 224 for processing. The signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one or more of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front end 254 may select signals received from one or more of the antennas 252 for processing. The signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal (e.g., which may be provided to a data sink 272).

In some aspects, the transceiver front end 254 (or 222), for example in combination with one or more components of the UT 120 (or AP 110) such as the controller 280 (or 230), may be used to perform RADAR operations using transmit and receive antennas while reducing effects of mutual coupling between the antennas 252, as described in more detail herein.

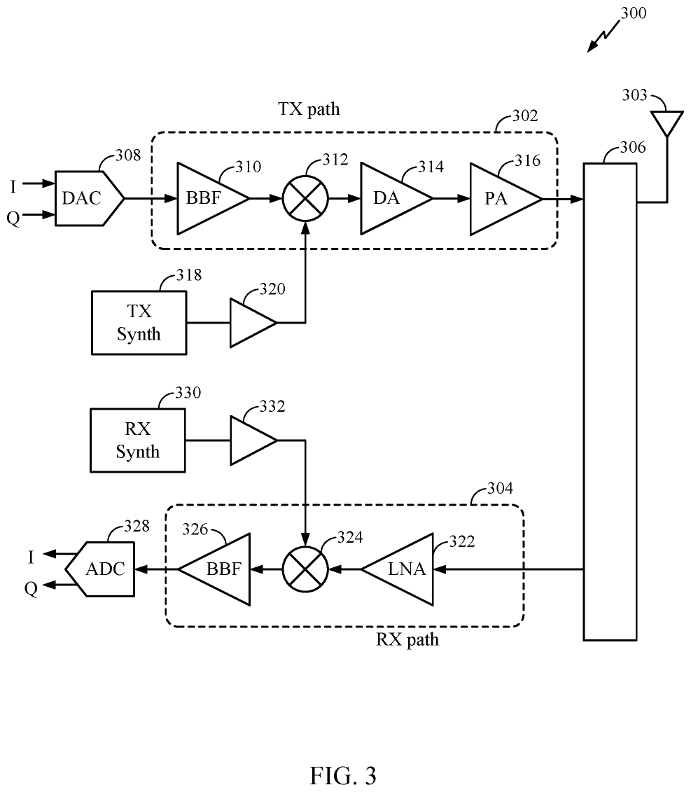

FIG. 3 is a block diagram of an example transceiver front end 300, such as transceiver front ends 222, 254 in FIG. 2, in which aspects of the present disclosure may be practiced. The transceiver front end 300 includes at least one transmit (TX) path 302 (also known as a “transmit chain”) for transmitting signals via one or more antennas and at least one receive (RX) path 304 (also known as a “receive chain”) for receiving signals via the antennas or other antennas. When the TX path 302 and the RX path 304 share an antenna 303, the paths may be connected with the antenna via an interface 306, which may include any of various suitable radio frequency (RF) devices, such as a switch, a duplexer, a diplexer, a multiplexer, and the like.

A digital-to-analog converter (DAC) 308, for example configured to receive in-phase (I) and/or quadrature (Q) baseband signals, is configured to provide analog signals to the TX path 302. The TX path 302 may include a baseband filter (BBF) 310, a mixer 312, a driver amplifier (DA) 314, and a power amplifier (PA) 316. Each of these components may include multiple stages. The BBF 310, the mixer 312, the DA 314, and the PA 316 may be included in a radio frequency integrated circuit (RFIC). In some cases, the PA 316 may be external to the RFIC. In other examples, a stage of the mixer 312, the DA 314, and the PA 316, but not the BBF 310 and potentially not another stage of the mixer 312, are included in an RFIC.

The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 312 are typically RF signals, which may be amplified by the DA 314 and/or by the PA 316 before transmission by the antenna 303. While one mixer 312 is illustrated, several mixers may be used to upconvert the filtered baseband signals to one or more intermediate frequencies and to thereafter upconvert the intermediate frequency (IF) signals to a frequency for transmission. In some examples, multiple TX paths may share a mixer and/or BBF.

The RX path 304 includes a low noise amplifier (LNA) 322, a mixer 324, and a baseband filter (BBF) 326. The LNA 322, the mixer 324, and the BBF 326 may be included in a radio frequency integrated circuit (RFIC), which may or may not be the same RFIC that includes the TX path components. In other examples, a stage of the mixer 324 and the LNA 322, but not the BBF 336 and potentially not another stage of the mixer 324, are included in an RFIC, which may be the same RFIC that includes certain of the TX path components. RF signals received via the antenna 303 may be amplified by the LNA 322, and the mixer 324 mixes the amplified RF signals with a receive local oscillator (LO) signal to convert the RF signal of interest to a different baseband frequency (i.e., downconvert). The baseband signals output by the mixer 324 may be filtered by the BBF 326 before being converted by an analog-to-digital converter (ADC) 328 to digital signals, for example in the form of I and/or Q signals, for digital signal processing. In some examples, multiple RX chains may share a mixer and/or BBF.

Certain transceivers may employ frequency synthesizers with a variable-frequency oscillator (e.g., a voltage-controlled oscillator (VCO) or a digitally controlled oscillator (DCO)) to generate a signal with variable frequency as in the case of frequency modulated continuous wave (FMCW)-based radar systems. In this case, the output of the VCO is a continuous wave (CW) tone with frequency increasing and/or decreasing over time, also known as a chirp. In general, the transmit LO frequency may be produced by a TX frequency synthesizer 318, which may be buffered or amplified by amplifier 320 before being mixed with the baseband signals in the mixer 312. Similarly, the receive LO frequency may be produced by an RX frequency synthesizer 330, which may be buffered or amplified by amplifier 332 before being mixed with the RF signals in the mixer 324. In some cases, a single frequency synthesizer may be used for both the TX path 302 and the RX path 304. Circuitry for generating an FMCW signal may be included in the synthesizer 318 and/or 330, or may be implemented separate from these components.

In some aspects, the transmit path may be used to transmit a signal and the receive path may be used to receive a signal, where the effect of mutual coupling between the transmit and receive paths may be reduced, as described in more detail herein. The transmit and/or receive path may be configured for RADAR (e.g., FMCW) signals. In some examples, the transmit and/or receive path may additionally be configured for data communications (e.g., with the AP 110 and/or a UE 120). In some examples, a device including the transmit and receive paths includes separate transmit and receive paths configured for data communications with the AP 110 and/or a UE 120. While examples are provided herein that reference FMCW signals, it will be understood that the various described innovations may be implemented in a device which additionally or alternatively uses other types of RADAR signals.

While FIGS. 1-3 describe an example configuration of a wireless communication system to facilitate understanding, the aspects of the present disclosure may be applied to any suitable device, electronic system, or other wireless communication system. For example, a wireless communication device may be implemented with a modem integrated circuit (IC), a transceiver IC, and a front-end module or a collection of front-end components. The modem IC may be part of a main system-on-chip (SoC) with an application processor, in some aspects. The modem IC may be coupled to the transceiver IC (e.g., a separate wireless local area network (WLAN) chip or a separate sub-6 GHz software-defined radio (SDR) chip). The transceiver IC may include baseband circuitry, mixers, and pre-amplifiers, for example. The transceiver IC may be coupled to the front-end module or components, which may include a PA, for example. Furthermore, the adaptive phase combining scheme described herein may be implemented using a plurality of Rx antennas greater than two.

### Example Techniques for Self-Jamming Cancellation

Certain aspects of the present disclosure are directed towards using frequency-modulated continuous wave (FMCW) for object detection (e.g., for maximum permissible exposure (MPE) compliance and other applications). Some wireless devices feature an integrated (FMCW) radio detection and ranging (RADAR) to mitigate the problem of human body exposure at millimeter-wave (mmW) frequency where an MPE of 1 mW/cm² is to be met at all times. FMCW may be used to detect objects near the wireless device. In some cases, the FMCW may be implemented with low transmit power (e.g., −23 dBm) to comply with the emission specifications in a licensed band specified by the Federal Communications Commission (FCC) or another regulatory organization.

FMCW or other RADAR signals may also be used for object detection for other applications, including automotive, sports, and internet-of-things (IoT) applications. Manufacturers are increasingly interested in extending RADAR to other applications unrelated to MPE, including sports activities (e.g., for golf ball velocity measurement) or IoT applications to enable robot movement or gesture detection. For such implementations, the object detection range using RADAR may be increased. Higher transmit power of a RADAR signal may be used to overcome path loss and increase the detection range of a sensor using RADAR. In some cases, an unlicensed band may be used for RADAR transmission; thus, a transmit power level of up to 13 dBm or higher may be allowed.

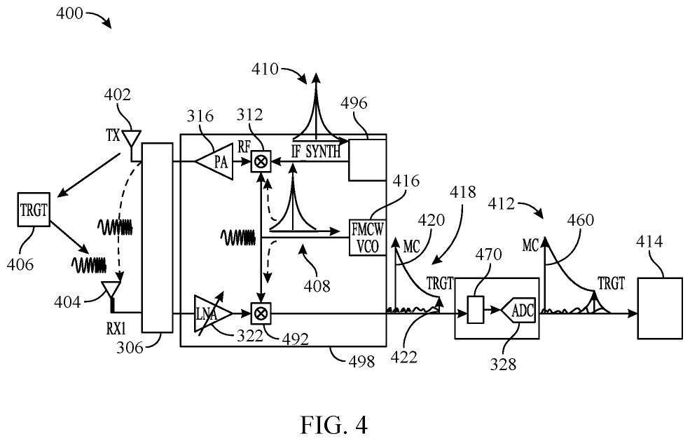

FIG. 4 illustrates self-jamming for a wireless communication circuit 400. As shown, the wireless communication circuit 400 includes an RFIC 498 with an FMCW voltage-controlled oscillator (VCO) 416 that generates an oscillating signal for FMCW, which is provided to mixers 312, 492, as shown. As shown in FIG. 4, the FMCW VCO 416 may be used to output a chirp. The mixer 312 mixes the oscillating signal with an intermediate frequency (IF) signal from an IF synthesizer 496. The mixed signal from the mixer 312 is amplified by the PA 316 and transmitted via antenna 402.

As shown, the transmission may reflect off of an object 406 (e.g., also referred to as a target labeled “TRGT”), and the reflection may be received by antenna 404. The received reflection is amplified by a low-noise amplifier (LNA) 322 and mixed with the oscillating signal from the FMCW VCO 416 by the mixer 492, to generate an IF signal. The IF signal from (e.g., at the output) of the mixer 492 may have a sinusoidal tone. The frequency of the sinusoidal tone may be proportional to the distance from the wireless communication circuit 400 to the object 406, allowing a distance to the object 406 to be determined. The frequency modulation in the FMCW may be implemented differently, and the method used to detect an object and/or distance thereto revised appropriately.

As shown, energy also couples from the antenna 402 to the receive antenna 404 due to the MC of the antennas 402, 404. FMCW object detection involves simultaneous transmission and reception at the same frequencies, which may result in transmit self-jamming (e.g., interference from transmitter to receiver) and associated phase noise. Weak isolation between transmit and receive antennas (e.g., due to small array size) may result in excessive transmit signal leakage in the receiver. Thus, a lower LNA gain may be used to avoid compression in front-end stages at the cost of increasing noise floor (NF). Uncancelled phase noise (PHN) originated by the IF synthesizer 496 (e.g., in the RFIC 498) may experience a boost in dBm due to the high level of MC at the receiver.

Diagram 408 shows a frequency component of the oscillating signal from the FMCW VCO 416 in the frequency domain, diagram 410 shows a frequency component of the IF signal from the synthesizer 496 in the frequency domain, and diagram 418 shows the signal output by mixer 492 in the frequency domain. Arrow 420 of diagram 418 shows the magnitude of the MC, and arrow 422 shows the magnitude of the reflected signal used for object detection. The magnitude of the MC grows linearly with transmit power from antenna 402. As the MC magnitude increases, the leakage from the MC to the reflected signal increases, making it difficult to increase transmit power to detect more distant objects for various applications.

The IF signal generated by the mixer 492 may be downconverted to a baseband (BB) frequency via a mixer 470 and converted from the analog domain to the digital domain via the analog-to-digital converter (ADC) 328. As shown by diagram 412, an MC component exists in the digital domain, represented by arrow 460. The digital signal is provided to a BB processor 414 for processing and object detection. The processor 414 may be implemented by or in the RX data processor 242, 270, the controller 230 (FIG. 2), or another processor or modem.

Self-cancellation may occur for the phase noise associated with the oscillating signal from the VCO 416 at the mixer 492 due to the correlation between transmit and receive signals. In other words, phase noise associated with the oscillating signal may be present at the output of the LNA 322, and thus, the phase noise is canceled at the mixer 492. Such self-cancellation does not occur for phase noise associated with the IF signal generated by synthesizer 496 shown by diagram 410, resulting in the MC shown by arrow 420 in diagram 418 at the output of mixer 492. Certain aspects of the present disclosure exploit the high correlation of MC (and phase noise) across adjacent antennas by applying phase shifts to associated receive signals such that MC associated with the receive signals have opposite phases, reducing MC amplitude and its associated phase noise.

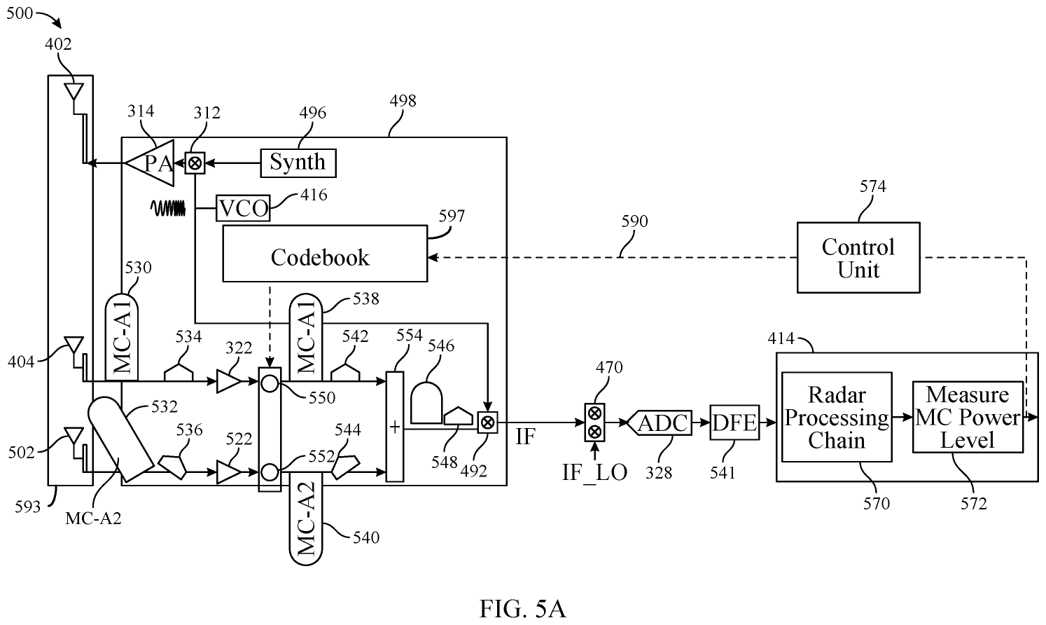

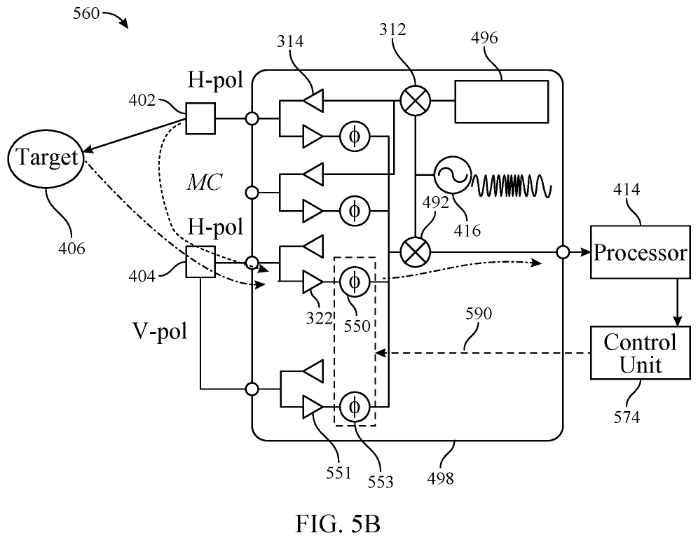

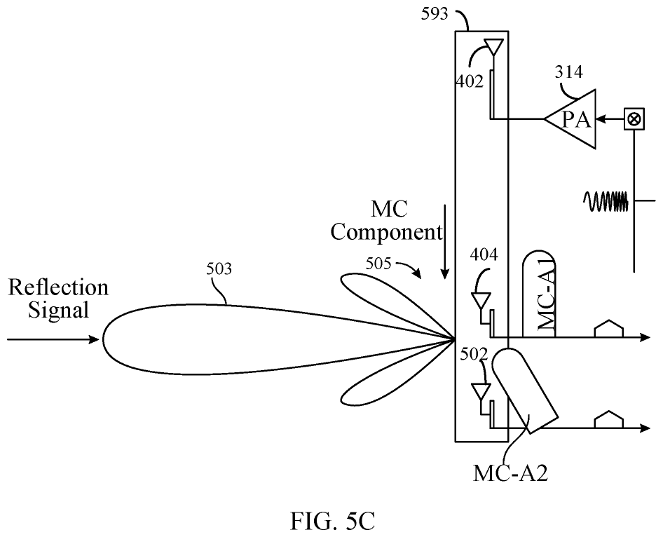

FIG. 5A illustrates a wireless communication circuit 500 with multiple receive antennas 404, 502, in accordance with certain aspects of the present disclosure. Due to the near-field nature of MC (e.g., from the transmit antenna to a receive antenna of the same device), it may be challenging to derive appropriate phase shifter values analytically. In some aspects of the present disclosure, a feedback path 590 (e.g., a feedback control loop) may be implemented to set phase shifter values in the receive chains and reduce the MC (and associated phase noise). For example, the feedback path 590 may be coupled to control inputs of adjustable phase shifters 550, 552. As shown, FMCW signals received by antennas 404, 502 may be amplified using respective LNAs 322, 522 and phase shifted using respective phase shifters 550, 552. The phase-shifted receive signals from phase shifters 550, 552 may be combined using a combiner 554. The combined signal from the combiner 554 may be downconverted from RF to IF via mixer 492, and from IF to BB frequency via mixer 470. The BB signal from the mixer 470 may be provided to a digital front-end (DFE) circuit 541 (including filtering, etc.) and to a BB processor 414. The BB processor 414 may include a RADAR processing chain 570 for processing the receive signal in the digital domain and a measurement circuit 572 for measuring the MC power level. During a calibration mode (or dynamically in some cases), the measurement circuit 572 may perform a power measurement indicating the power level of the MC component at the output of the combiner 554. The measured MC component power level may be provided to a control unit 574. The control unit 574 may perform an iterative search in a codebook or otherwise determine phase setting for phase shifters 550, 552 that reduces the MC component power level (and reduces associated phase noise). For example, a number of different phase shift combinations (e.g., as represented by different entries in the codebook) may be searched until an MC component power level that is lower than a threshold is identified for one of the phase shift combinations. For instance, a phase shift combination may be set, the MC may be measured, then the phase shift combination may be adjusted, and the MC may be measured again, and so on, until an MC that meets a certain threshold is identified. In some cases, a certain number of phase shift settings (e.g., phase shift combinations) may be searched and the lowest measured MC may be selected. The number of phase shift settings searched may be a subset of all possible phase shift settings, in some cases, although all possible phase settings may be searched in some implementations. The order of the phase settings to be searched may be selected using any suitable technique. For example, the phase shift settings may be searched randomly or based on a certain algorithm. As one example, the phase shift for a first phase shifter may be held constant while the phase shift for a second phase shifter is adjusted to find a minimum MC power level (or an MC power level that meets a first threshold). Once the phase shift for the first phase shifter is identified, the phase shift for the second phase shifter may be adjusted to further reduce the MC power level (e.g., until the MC power level meets a second threshold, lower than the first threshold).

In some aspects, the phase shift settings may be stored in a storage device 597 (e.g., labeled “Codebook”). The control unit 574 may send an indication (e.g., an index) to select one of the phase shift settings from the storage device 597 which may be used to configure the phase shifters 550, 552. In some cases, the phase shift settings may be stored in memory (e.g., memory 232 of FIG. 2) external to the RFIC 498, where one of the phase shift settings is selected by the control unit 574 to configure the phase shifters. In some such examples, the storage device 597 is omitted.

In some aspects, a phase noise measurement component configured to measure phase noise may be used in addition to or alternative to the measurement circuit 572. The phase shift settings may be determined based on the measurements from the phase noise measurement component, for example by iteratively searching a codebook or otherwise determining phase setting for phase shifters 550, 552 using the control unit 574, as described above, such that phase noise measured by such component is reduced.

Once the phase-shifter settings are identified, the settings may be used during RADAR operations to detect the object. While the power level of the MC may be measured during calibration in some implementations, the power level of the MC may be measured dynamically (e.g., while the wireless device is deployed in the field) to dynamically estimate phase settings. The control unit 574 may be implemented by or in the controller 230 (FIG. 2) and/or may be included in the processor 414.

The impact to the energy of the reflection component in the receive chain may be low due to the independent phase signatures between the reflection component and the MC component across the antennas. For example, the phase offset between the MC phase 530 from antenna 404 (e.g., labeled “MC-A1”) and MC phase 532 from antenna 502 (e.g., labeled “MC-A2”) may be different than the phase offset between the reflection phase 534 from antenna 404 and reflection phase 536 from antenna 502. After a phase offset is applied via one or more of phase shifters 550, 552, the MC phase 538 from antenna 404 may be offset (e.g., 180° offset, as shown) from the MC phase 540 from antenna 502, resulting in a reduction of the magnitude of the MC component 546 (e.g., with little to no impact to the magnitude of the reflection component 548) at the output of the combiner 554. As shown, at the output of phase shifters 550, 552, the reflection phase 542 may not be 180° offset from the reflection phase 544, and thus, the phase shifting may have little to no impact on the magnitude of the reflection component 548 at the output of the combiner 554. While some examples provided herein use phase adjustment to reduce MC component magnitude, gain adjustment may also be used in some aspects. For example, in addition to performing phase adjustment, the gain associated with LNA 322 and/or LNA 522 may be adjusted to reduce the MC component magnitude.

While the example techniques for reducing MC are described with a measurement circuit in processor 414, the aspects of the present disclosure may be implemented with power measurement in the RFIC 498 or power measurement in the IF domain. For example, a power measurement circuit may be implemented at the output of the combiner 554 to measure the power associated with the MC component and control the phase shifters 550, 552 accordingly.

The RFIC 498 may include elements other than those illustrated, for example filters, etc. and/or components that facilitate data communication. Further, components illustrated as being outside of RFIC 498, e.g., the mixer 470, in FIG. 5A may instead be implemented in the RFIC 498. In some examples, two or more (e.g., all) of the antennas 402, 404, 502 are implemented on a common substrate, represented by 593. In some examples, the RFIC 498 and the antennas 402, 404, 502 (and the substrate or plurality of substrates on which they're implemented) are packaged together in a module.

In some aspects, signals of different (e.g., orthogonal) polarization may be used to sample mutual coupling and cancel (or at least reduce) the mutual coupling using gain and phase adjustment, as described in more detail herein. In some examples, this includes a delay (e.g., due to transmission over the air), as might certain examples described with respect to FIG. 5A. Thus, when using over-the-air (OTA) coupling, a delay circuit may be omitted from certain configurations of the RFIC (e.g., a delay circuit that would otherwise account for different signal paths of the MC component within the RFIC and reflection component may not be used). An algorithm may be used to adjust the phase setting(s) of phase shifter(s) and/or LNA gain(s) to reduce mutual coupling via a closed-loop system, as described.

FIG. 5B illustrates a wireless communication circuit 560 receiving horizontal polarization (H-pol) and vertical polarization (V-pol) signals from a receive antenna 404, in accordance with certain aspects of the present disclosure. A transmit signal may be amplified via PA 316 and transmitted via antenna 402. The MC component and reflection component may be received via antenna 404. The antenna 404 may have a horizontal polarization output coupled to an input of the LNA 322 and a vertical polarization output coupled to an input of an LNA 551. Both the MC component and the reflection component may be present at the input of the LNA 322 and at the input of the LNA 551. In some aspects, the output of LNA 322 is coupled to an input of phase shifter 550, and the output of the LNA 551 may be coupled to an input of a phase shifter 553. The outputs of phase shifters 550, 553 are coupled to the input of mixer 492, as shown.

As described with respect to FIG. 5A, the processor 414 may include a measurement circuit (e.g., measurement circuit 572 shown in FIG. 5A) that may make a power measurement indicating the power of the MC signal at the output of mixer 492. Based on the power measurement, the control unit 574 may control at least one of the phase shifters 550, 553 to reduce the magnitude of the MC component (e.g., to cancel all of a portion of the MC component when phase shifted signals on the paths coupled to the respective polarization feeds of the antenna 404 are combined).

Certain of the components illustrated in FIG. 5A are omitted for ease of illustration, but may be implemented in the wireless communication circuit 560. For example, the mixer 470 in a super-heterodyne system, the ADC 328, the DFE 541, etc. may be implemented in the circuit 560. Antenna 402 is shown as being coupled to both transmit and receive elements in FIG. 5B. If present, such elements may not be coupled to other such circuitry coupled to other antenna elements. Similarly, antenna 404 is shown as being coupled to both transmit and receive elements in FIG. 5B. If present, such elements may not be coupled to other such circuitry coupled to other antenna elements. The receive circuitry coupled to antenna 402 may be omitted in some examples and/or the transmit circuitry coupled to antenna 404 may be omitted in some examples. In other examples, such receive and/or transmit circuitry is included in the example shown in FIG. 5A. Further, a port is shown as being coupled to transmit and receive circuitry, but not to an antenna. Such transmit and/or receive circuitry may be omitted, or may be coupled to an antenna. Such antenna is not shown in FIG. 5B to represent that it is not required, but transmit or receive functionality (for a RADAR or data communication signals) may be used with such antenna in some examples.

FIG. 5C illustrates different receive directions associated with the MC component and the reflection component. The receive direction of the reflection may, of course, vary, but the receive direction of the MC component likely will not significantly change for a certain setting (e.g., the use of a certain antennas) of the related circuitry. Due to the different receive directions of the MC component and the reflection component, modifying the phase shifter values (e.g., settings) across the antennas and/or polarizations to combine associated MC components in opposite phases as described with respect to FIG. 5A may have little to no impact on the combined reflection component energy. The impact to the reflection component magnitude may be minor due to the object to be detected being relatively far from the device (e.g., as compared to the distance between the transmit and receive antennas). As a result, the MC and reflection components may have different phase signatures, as described herein. The signal from antenna 404 may be calculated based on the following expression:

e^{j∅}^{₁}S_{MC}(t)+e^{jθ}^{₁}S_{TRGT}(t)+n_{w1}

where ∅₁ is the spatial phase associated with the MC component from antenna 404, S_{MC}(t) represents the amplitude of the MC component of the signal from antenna 404, θ₁ is the spatial phase associated with the reflection signal from antenna 404, and S_{TRGT}(t) represents the reflection component amplitude from antenna 404. The signal from antenna 502 may be calculated based on the following expression:

e^{j∅}^{₂}S_{MC}(t)+e^{jθ}^{₂}S_{TRGT}(t)+n_{w2}

where ∅₂ is the spatial phase associated with the MC signal from antenna 502, S_{MC}(t) represents the MC component magnitude of the signal from antenna 502 (e.g., same as MC component magnitude for antenna 404), θ₂ is the spatial phase associated with the reflection component from antenna 502, and S_{TRGT}(t) represents the reflection component from antenna 502 (e.g., same as TRGT signal magnitude for antenna 404). The spatial phase signatures represented by θ₂ and ∅₂ are different, and thus, implementing phase shifts to reduce the MC component magnitude may have little to no impact on the reflection component magnitude.

While some examples provided herein have been described with one transmit antenna, one receive antenna outputting two polarizations, and/or two receive antennas to facilitate understanding, the aspects of the present disclosure may be applied with any number of antennas. For example, in some cases, two receive antennas each outputting two polarizations or three or four receive antennas may be coupled to respective phase shifters that may be controlled to reduce the MC component or the transmit signal may beamformed with multiple transmit antennas. In some such examples, target beamforming with multiple receive antennas and mutual coupling reduction may be achieved simultaneously by placing a null on the mutual coupling path. For example, as alluded to in the description of FIG. 5C above, by adjusting the phase offsets of associated phase shifters 550, 552 (and other phase shifters if additional receive paths are being used), a main lobe 503 (e.g., main beam) for signal reception may be directed (steered) towards the object to be detected to increase gain for receiving the reflection component, while a null beam (e.g., null beam 505) may be directed (steered) towards the transmit antenna(s) or otherwise toward the direction of the mutual coupling, reducing the magnitude of the MC component. In some examples, using more than two receive chains allows for the cancellation or reduction not only of the main lobe main lobe of the mutual coupling, but additionally of side lobes.

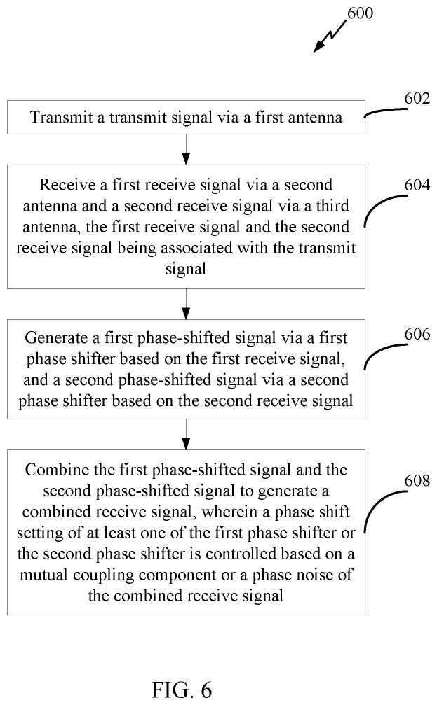

FIG. 6 is a flow diagram illustrating example operations 600 for object detection, in accordance with certain aspects of the present disclosure. The operations 600 may be performed by an object detection circuit of a device, such as the wireless communication circuit 500.

At block 602, the object detection circuit may transmit a transmit signal (e.g., a RADAR signal, which may comprise an FMCW signal) via a first antenna (e.g., antenna 402 of FIG. 5A). At block 604, the object detection circuit may receive a first receive signal via a second antenna (e.g., antenna 404 of FIG. 5A) and a second receive signal via a third antenna (e.g., antenna 502 of FIG. 5A). In some aspects, the second antenna and the third antenna may be different antennas. The signals may be received by the second and third antennas over the air. Blocks 602 or 604 may be performed substantially concurrently.

The first receive signal and the second receive signal may be associated with the transmit signal. For example, each of the first receive signal and the second receive signal may include a target reflection component associated with a reflection of the transmit signal from an object (if present). The first, second, and third antennas may be included in an antenna array. In some examples, all three antennas are implemented on a common substrate. A longest dimension of the antenna array may be on the order of several inches (or less), and the object may be several (or tens or hundreds) of feet away. Thus, the object may be separated from the antenna array by a distance that is an order of magnitude (or several orders of magnitude of more) greater than a longest dimension of the array.

At block 606, the object detection circuit may generate a first phase-shifted signal via a first phase shifter (e.g., phase shifter 550 of FIG. 5A) based on the first receive signal, and a second phase-shifted signal via a second phase shifter (e.g., phase shifter 552 of FIG. 5A) based on the second receive signal.

At block 608, the object detection circuit may combine (e.g., via combiner 554) the first phase-shifted signal and the second phase-shifted signal to generate a combined receive signal. A phase-shift setting of at least one of the first phase shifter or the second phase shifter may be controlled (e.g., via control unit 574) based on a mutual coupling component or a phase noise of the combined receive signal. For example, the phase-shift setting of at least one of the first phase shifter or the second phase shifter may be controlled to reduce the mutual coupling component or the phase noise of the combined receive signal. The mutual coupling or the phase noise may be reduced over time. For example, by controlling the phase-shift setting, the mutual coupling may be reduced as compared to a mutual coupling or phase noise associated with a previous object detection operation. In some cases, the phase-shift setting may be controlled such that the mutual coupling component or phase noise is less than a certain threshold. The threshold may be any suitable threshold that may be dynamically set for the antenna configuration of the device or preconfigured. In some cases, the mutual coupling (or phase noise) may be reduced to be less than a mutual coupling (or phase noise) associated with a single antenna. For instance, the phase-shift setting may be reduced such that the mutual coupling 546 shown in FIG. 5A is less than the mutual coupling at input of LNA 322.

The mutual coupling component may be associated with a signal received by the second antenna and the third antenna directly from the first antenna. In some aspects, the object detection circuit may detect an object based on the combined receive signal. Detecting the object may involve detecting a distance from the device to the object based on a frequency of the combined receive signal.

In some aspects, the first receive signal may include a horizontal polarization signal, and the second receive signal may include a vertical polarization signal (e.g., as described with respect to FIG. 5B). The second antenna and the third antenna may be the same antenna (e.g., antenna 404 of FIG. 5B) configured to provide the horizontal polarization signal and the vertical polarization signal.

In some aspects, the object detection circuit may measure (e.g., via measurement circuit 572 of FIG. 5A) a power associated with the mutual coupling component and determine the phase-shift setting of at least one of the first phase shifter or the second phase shifter based on the power. The power associated with the mutual coupling component may be measured in a digital domain (e.g., via processor 414). In some aspects, the phase-shift setting may be controlled such that a mutual coupling component of the first phase-shifted receive signal is 180° out-of-phase from the mutual coupling component of the second phase-shifted receive signal.

In some aspects, the object detection circuit may amplify (e.g., via LNA 322) the first receive signal to yield a first amplified receive signal, the first phase-shifted receive signal being generated based on the first amplified receive signal. The object detection circuit may amplify (e.g., via LNA 522) the second receive signal to yield a second amplified receive signal, the second phase-shifted receive signal being generated based on the second amplified receive signal.

The operations 600 may be performed every time a transmission occurs by the device for object detection. The determination of phase shifts to be used to reduce mutual coupling may be performed prior to each object detection operation or may be performed less often in some implementations. For example, the phase shift settings may be determined once (e.g., in factory), during a device initialization process, each time the RADAR for object detection is turned on, or each time one or more settings of the RADAR are changed (e.g., each time antennas used for object detection are changed). The phase shift settings may be determined periodically in some cases (e.g., after a certain number of seconds or minutes). In some aspects, the processors (e.g., BB processor 414 of FIG. 4) may be used to check the MC power level occasionally, and if the MC power level changes more than a certain threshold, new phase shift settings may be identified.

Certain aspects of the present disclosure are directed towards techniques for canceling an MC component at a receive port using a signal path internal to the device (e.g., as opposed to exclusively an OTA path as described with respect to FIG. 5A). Using the signal path internal to the device may free up one or more antenna elements to be used for signal transmission or reception, increasing transmit or receive power. Self-interference cancellation (SIC) involves gain and phase control of a reference signal (e.g., also referred to herein as an “adjustment signal”) generated within the chip, which may be achieved by using an unused receive or transmit path within a phased array RF integrated circuit (RFIC). Thus, available gain stages and phase shifters may be used to achieve gain and phase adjustment.

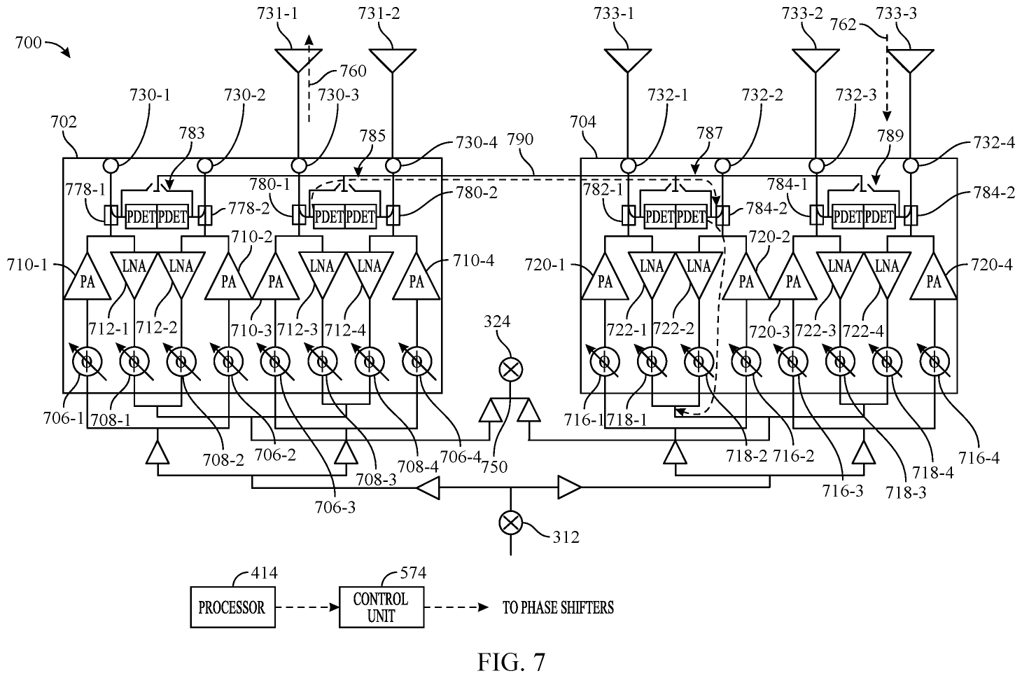

FIGS. 7, 8, and 9 illustrate a wireless communication circuit 700. Separate RFICs 702, 704 may be implemented, or all of the components in RFICs 702, 704 may be included in the same RFIC. The signal path 790, the mixer 312, the amplifiers coupled between the mixer 312 and 702 and 704, the mixer 324, and the amplifiers coupled between 702 and 704 and the mixer 324 may also be in that same RFIC. One of the RFICS 702, 704, or the combined RFIC having all the components, may be utilized to implement the RFIC 498 (FIG. 5A), or antennas in FIG. 5A may be spread out across the RFICs 702, 704. In some examples, RFICs 702, 704 are configured for transmission of different frequencies and/or of different polarizations. In other examples, 702 and 704 are configured for use with signals have the same frequency and/or polarization. Certain components illustrated in FIG. 5A are omitted for ease of illustration, but may be implemented in the wireless communication circuit 700. For example, the mixer 470 in a super-heterodyne system, the ADC 328, the DFE 541, the processor 414, the control unit 574, etc. may be implemented in the circuit 700, for example coupled to an output of the mixer 324.

In some aspects, a signal from a transmit chain may be provided to a coupler of an unconnected receive chain (e.g., a receive chain not connected to an antenna or not used for reception) for a receive chain (e.g., associate with an antenna array) to perform gain and phase scaling. A phase-shifted signal may be combined with a receive signal of another receive chain to process a reflection component of the receive signal before downconversion, as described in more detail herein.

As shown in FIG. 7, a mixer 312 may be used to generate an RF signal that may be provided to the RFICs 702, 704. The output of the mixer 312 may be coupled to inputs of transmit path adjustable phase shifters 706-1, 706-2, 706-3, 706-4 (collectively referred to as “phase shifters 706”) of the RFIC 702. The outputs of phase shifters 706 may be coupled to respective inputs of PAs 710-1, 710-2, 710-3, 710-4. The RFIC 702 also includes LNAs 712-1, 712-2, 712-3, 712-4 having outputs coupled to respective inputs of receive path adjustable phase shifters 708-1, 708-2, 708-3, 708-4 (collectively referred to as “phase shifters 708”). As shown, outputs of phase shifters 708 may be coupled to mixer 324 for downconversion from RF to intermediate frequency (IF) or BB frequency for further processing.

The RFIC 702 may include port 730-1 coupled to PA 710-1 and LNA 712-1, port 730-2 coupled to PA 710-2 and LNA 712-2, port 730-3 coupled to PA 710-3 and LNA 712-3, and port 730-4 coupled to PA 710-4 and LNA 712-4. As shown, ports 730-1 and 730-2 may be unused in some implementations. Ports 730-3 and 730-4 may be coupled to respective antennas 731-1, 731-2 for transmission or reception. Antennas may be coupled to the unused ports in some examples, for example such that they can be disconnected from an associated receive chain when not in use. Chains that are not utilized for the operations described below may be omitted in some examples. In some examples, an unused port is not coupled to an antenna.

Similarly, RFIC 704 may include transmit path adjustable phase shifters 716-1, 716-2, 716-3, 716-4 having outputs coupled to respective inputs of PAs 720-1, 720-2, 720-3, 720-4. The RFIC 704 also includes LNAs 722-1, 722-2, 722-3, 722-4 having outputs coupled to respective inputs of receive path adjustable phase shifters 718-1, 718-2, 718-3, 718-4. As shown, the RFIC 704 may include port 732-1 coupled to PA 720-1 and LNA 722-1, port 732-2 coupled to PA 720-2 and LNA 722-2, port 732-3 coupled to PA 720-3 and LNA 722-3, and port 732-4 coupled to PA 720-4 and LNA 722-4. Ports 730-1, 730-2, 730-3, and 730-4 are collectively referred to as “ports 730,” and ports 732-1, 732-2, 732-3, and 732-4 are collectively referred to as “ports 732.”

As shown, port 732-2 may be unused in some implementations. Ports 730-1, 730-3, and 730-4 may be coupled to respective antennas 733-1, 733-2, and 733-3 for transmission and reception. In some aspects, a signal path 790 may be implemented between transmit and receive chains of the RFICs 702, 704. For example, the signal path 790 may be persistently or selectively coupled between the transmit chain (e.g., port 730-3) for antenna 731-1 and an unused receive path (e.g., a receive path coupled to an unused port, such as port 732-2). The signal path 790 facilitates gain and phase scaling to reduce a MC component and/or phase noise of a receive signal.

The signal path 790 in the illustrated example may be used to selectively couple any one of ports 730, 732 to one or more other one of the ports 730, 732. For example, the signal path 790 may be selectively coupled via switches 783 to ports 730-1, 730-2 through respective couplers 778-1, 778-2. The signal path 790 may be selectively coupled via switches 785 to ports 730-3, 730-4 through respective couplers 780-1, 780-2. The signal path 790 may be selectively coupled via switches 787 to ports 732-1, 732-2 through respective couplers 782-1, 782-2. The signal path 790 may be selectively coupled via switches 789 to ports 732-3, 732-4 through respective couplers 784-1, 784-2. As shown, each of the couplers may be coupled to a power detector (labeled “PDET”), a receive chain, and/or a transmit chain. In other examples, a receive and/or transmit chain and/or a PDET not being used in the present operation may be omitted.

A transmit signal 760 may be transmitted via antenna 731-1. As shown in FIG. 7, using coupler 780-1, a portion of the transmit signal at the output of PA 710-3 may be electrically routed to the input of LNA 722-2 using the signal path 790 (e.g., through couplers 780-1, 782-2). A receive signal 762 may be received via antenna 733-3. The receive signal 762 may be amplified via LNA 722-4 (e.g., and phase shifted via phase shifter 718-4) and provided to node 750 at input of mixer 324. Similarly, the signal (e.g., referred to herein as an “adjustment signal”) provided through the signal path 790 may be amplified via LNA 722-2 (e.g., for amplitude adjustment) and phase-shifted via phase shifter 718-2 and provided to the same node 750. For example, during a calibration mode, the processor 414 may perform an MC component power measurement (or phase noise measurement) indicating the MC component power at the input of mixer 324, based on which the control unit 574 may control the phase shifter 718-2 (e.g., and/or gain of LNA 722-2 for amplitude adjustment) to reduce the MC component (and/or phase noise) at node 750 (e.g., reducing the effect of MC or phase noise associated with receive signal 762 received via antenna 733-3). The setting for the phase shifter 718-2 may be used during RADAR operations to detect the object while reducing the MC component and/or phase noise. The phase shifter 718-4 (e.g., and/or the gain of LNA 722-4 for amplitude adjustment) may be used in addition or instead of the phase shifter 718-2 and/or the LNA 722-2. In some examples, adjusting components of an unused chain may allow for MC reduction or cancellation (and/or phase noise reduction) without affecting reception of a reflected signal. The combination of signals may occur earlier in the chain than at node 750.

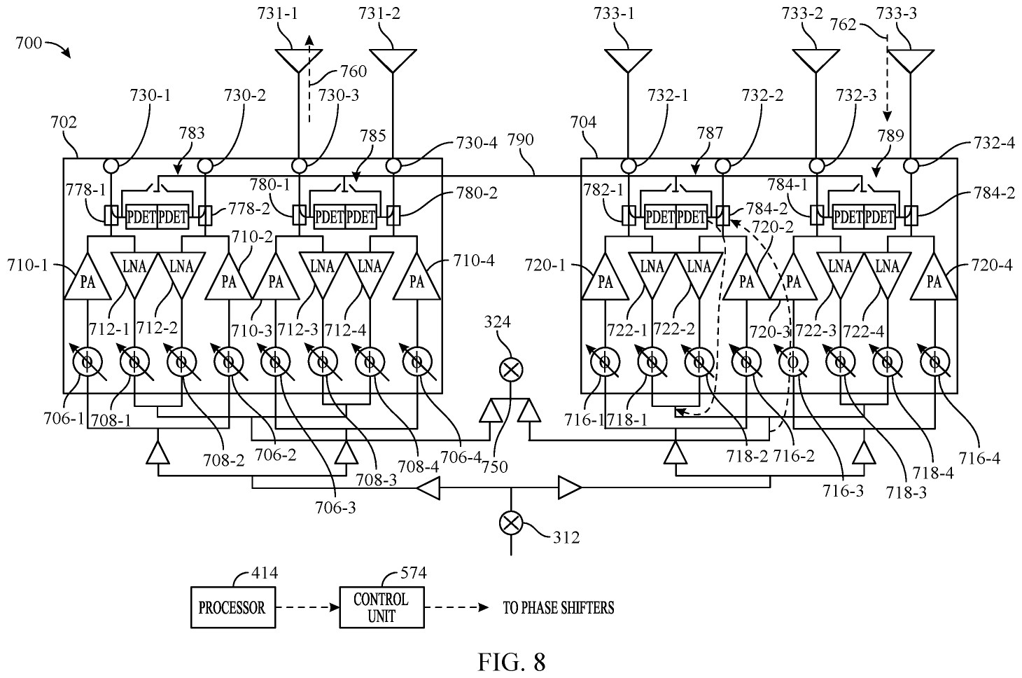

In some aspects, an unused transmit chain (e.g., unused for signal transmission) may be configured in a low-power mode of operation and used for MC cancellation or phase noise reduction. A receive chain may be enabled simultaneously with the unused transmit chain to couple at least a portion of the signal from the unused transmit chain to the receive chain, as described in more detail with respect to FIG. 8. The signal from the unused transmit chain may be combined with a receive signal from the receive chain to process a reflected component before downconversion. Gain and/or phase programming of the unused transmit chain and/or the receive chain may be used to reduce mutual coupling and phase noise as described herein.

As shown in FIG. 8, while transmitting via antenna 731-1 and receiving via antenna 733-3, the mixer output signal generated by mixer 312 may be provided to the phase shifter 716-2 and to the input of the LNA 722-2. The transmit signal may be provided to the input of LNA 722-2 either through the PA 720-2 configured in a low-power (e.g., low-gain) mode or with the PA 720-2 being bypassed and turned off (bypass circuitry not illustrated). As described, the output of LNA 722-2 is coupled to an input of phase shifter 718-2. The outputs of phase shifter 718-2 and phase shifter 718-4 are coupled to node 750. Thus, by controlling transmit chain phase shifter 716-2 and receive chain phase shifter 718-2, the MC component (and/or phase noise) at node 750 may be canceled (e.g., reduced), for example when combined with the phase shifted and amplified version of the receive signal 762. For example, as described herein, during a calibration mode, the processor 414 may perform an MC component power measurement indicating the MC component power at the input of mixer 324 (and/or may measure phase noise), based on which the control unit 574 may control the phase shifter 716-2, the phase shifter 718-2, or both phase shifters 716-2, 718-2 (e.g., and in some cases, associated gain of PA 720-2 and/or LNA 722-2 for amplitude adjustment) to reduce the MC component (and/or phase noise) magnitude. Once phase-shifter settings are identified during the calibration mode, the phase-shifter settings may be used during RADAR operations. The signal path 790 may be omitted in this example.

While certain examples provided herein have been described for multi-Tx/Rx antenna devices, the aspects of the present disclosure may be applied for single Rx antenna and single Tx antenna systems. For example, the implementation described with respect to FIG. 8 may be configured with only antenna 731-1 being used for transmission and only antenna 733-3 being used for reception, where phase shifter 716-4 and PA 720-4 (e.g., configured in bypass or low-power mode) are used to generate an adjustment signal to be provided to the input of LNA 722-4 and reduce the effect of MC and/or phase noise.

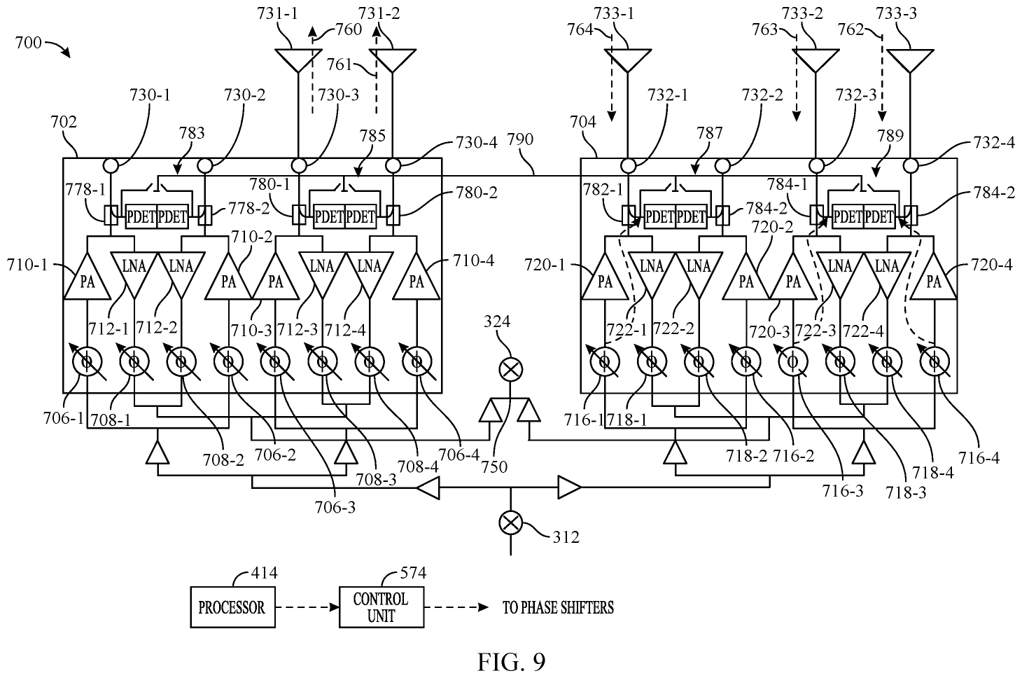

In certain aspects, for each receive chain used during RADAR operations, an associated transmit chain (e.g., sharing an antenna with the receive chain) may be used to provide gain and/or phase programmability, as described in more detail with respect to FIG. 9. Gain and/or phase programming of multiple transmit paths may be controlled to reduce mutual coupling and phase noise.

As shown in FIG. 9, in some aspects, one or more antennas may be used for signal transmission, and one or more antennas may be used for signal reception. For example, PAs 710-3 and 710-4 may be used for transmitting signals 760, 761 via antennas 731-1, 731-2, respectively. Signals 762, 763, 764 may be received via antennas 733-3, 733-2, and 733-1 and amplified via LNAs 722-4, 722-3, and 722-1, respectively. In some aspects, phase shifters 716-1, 716-3, 716-4 may generate phase-shifted signals based on the mixer output signal at the output of the mixer 312. The phase-shifted signals may be provided to respective inputs of LNAs 722-1, 722-3, 722-4 (e.g., while PAs 720-1, 720-3, 720-4 are turned off/bypassed (bypass path/circuitry not illustrated) or configured in low-gain mode) to reduce the MC component and/or phase noise. For example, during a calibration mode, the processor 414 may perform an MC component power measurement indicating the MC component power at the input of mixer 324 (and/or may measure phase noise), based on which the control unit 574 may control one or more of phase shifters 716-1, 716-3, and 716-4 (e.g., and/or gain of LNAs 722-1, 722-3, 722-4 for amplitude adjustment) to reduce the MC component and/or phase noise, e.g., at the node 750. Once phase-shifter settings are identified during the calibration mode, the phase-shifter settings may be used during RADAR operations. The signal path 790 may be omitted in this example.

With the techniques described herein, effects of MC and/or phase noise may be reduced during signal reception, allowing greater transmit power or usage of a greater number of transmit antennas during RADAR operations (e.g., for greater detection range). Excessive transmit self-jamming power level makes it challenging for FMCW implementations in mobile devices to achieve higher levels of transmit power (e.g., 10 dBm or greater) that are important for applications beyond MPE, such as gesture recognition or automotive (e.g., to detect objects, vehicles, or people or animals). Certain aspects of the present disclosure reduce the effects of self-jamming by changing phase-shifter settings to destructively combine mutual coupling components, reducing the MC component and the associated phase noise at the receiver.

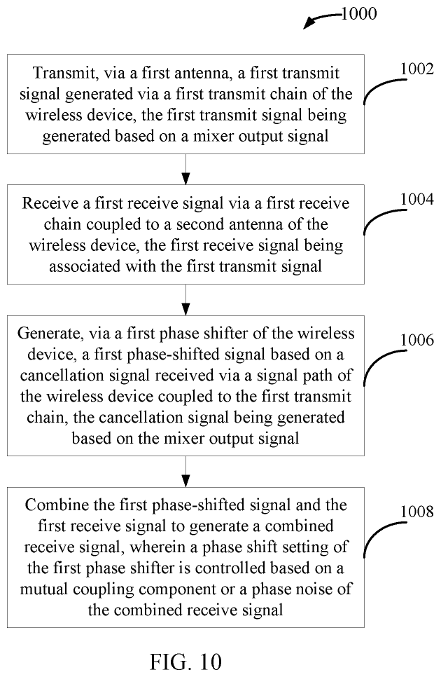

FIG. 10 is a flow diagram illustrating example operations 1000 for wireless communication, in accordance with certain aspects of the present disclosure. The operations 1000 may be performed, for example, by an object detection circuit of device, such as the wireless communication circuit 700.

At block 1002, the object detection circuit may transmit, via a first antenna (e.g., antenna 731-1 of FIG. 7, 8, or 9), a first transmit signal (e.g., an FMCW signal such as the transmit signal 760) generated via a first transmit chain of the device, the first transmit signal being generated based on a mixer output signal (e.g., output signal of mixer 312).

At block 1004, the object detection circuit may receive a first receive signal via a first receive chain coupled to a second antenna (e.g., antenna 733-3) of the device, the first receive signal being associated with the first transmit signal.

At block 1006, the object detection circuit may generate, via a first phase shifter (e.g., phase shifter 718-2) of the device, a first phase-shifted signal based on an adjustment signal received via a signal path (e.g., signal path 790) of the device coupled to the first transmit chain. The adjustment signal may be generated based on the mixer output signal. In some aspects, the object detection circuit may further control an amplitude of at least one of the first phase-shifted signal or the second phase-shifted signal based on the adjustment signal.

At block 1008, the object detection circuit may combine (e.g., at node 750 or earlier in the chain so the combination is present at the node 750) the first phase-shifted signal and the first receive signal to generated a combined receive signal. A phase-shift setting of the first phase shifter may be controlled to reduce a mutual coupling component or a phase noise of the combined receive signal.

In some aspects, the first phase shifter is part of a second receive chain (e.g., receive chain including LNA 722-2 and phase shifter 718-2) of the device. The signal path may be between the first transmit chain and the second receive chain. The second receive chain may be coupled to an unused antenna port (e.g., port 732-2 of FIG. 7). An unused antenna port may be an antenna port that is not being used to receive (over the air) signals (e.g., at the time of signal transmission for object detection). An unused antenna port may be a port that is not connected to an antenna or not being used to transmit a signal over the air, in some cases.

In some aspects, the object detection circuit generates, via an amplifier (e.g., PA 710-3) of the first transmit chain, the first transmit signal for transmission via the first antenna. The adjustment signal may be received through a coupler (e.g., coupler 780-1) coupled to an output of the amplifier of the first transmit chain.

In some aspects, the signal path of the device may include a second transmit chain (e.g., transmit chain including PA 720-2 of FIG. 8) of the device. The object detection circuit may generate the adjustment signal via a second phase shifter (e.g., phase shifter 716-2 of FIG. 8) of the second transmit chain. A phase-shift setting of the second phase shifter may be controlled to reduce the mutual coupling component or the phase noise of the combined receive signal. In some aspects, the second transmit chain may include an amplifier (e.g., PA 720-2 of FIG. 8) coupled to an output of the second phase shifter. The amplifier may be bypassed or configured in a low-gain mode while the adjustment signal is generated via the second phase shifter.

In some aspects, the second transmit chain (e.g., transmit chain including 720-4 of FIG. 9) is coupled to the second antenna (e.g., antenna 733-3 of FIG. 9). The object detection circuit may receive a second receive signal via a third receive chain coupled to a third antenna (e.g., antenna 733-2 of FIG. 9) of the device, the second receive signal being associated with the first transmit signal. The object detection circuit may generate, via a second phase shifter (e.g., phase shifter 716-3 of FIG. 9) of a second transmit chain of the device, a second phase-shifted signal. In this case, the combined receive signal may be generated by combining the first phase-shifted signal, the first receive signal, and the second phase-shifted signal. A phase-shift setting of the second phase shifter is controlled to reduce the mutual coupling component or the phase noise of the combined receive signal. In some aspects, the second transmit chain is coupled to the third antenna (e.g., antenna 733-2 of FIG. 9).

In some aspects, the first receive signal may include a target reflection component associated with a reflection of the first transmit signal from an object. The object detection circuit may detect the object based on the combined receive signal. Detecting the object may include detecting a distance from the device to the object based on a frequency of the combined receive signal. The mutual coupling component may be associated with a signal received by the second antenna directly from the first antenna.

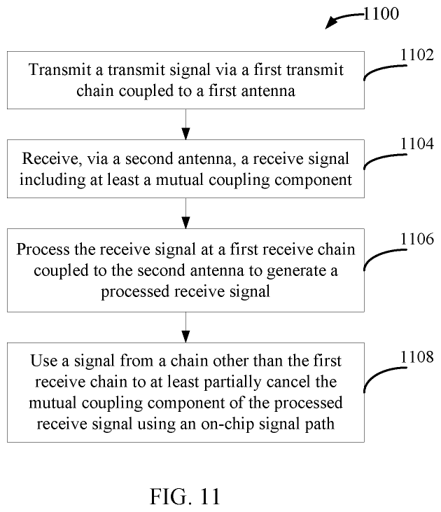

FIG. 11 is a flow diagram illustrating example operations 1100 for wireless communication, in accordance with certain aspects of the present disclosure. The operations 1100 may be performed, for example, by an object detection circuit of a device, such as the wireless communication circuit 500 or the wireless communication circuit 700.

At block 1102, the object detection circuit transmits a transmit signal via a first transmit chain coupled to a first antenna (e.g., antenna 402 of FIG. 5A or antenna 731-1 of FIGS. 7-9). At block 1104, the object detection circuit receives, via a second antenna (e.g., antenna 404 of FIG. 4 or antenna 733-3 of FIGS. 7-9), a receive signal including at least a mutual coupling component. In some aspects, the receive signal further includes a reflection component.

At block 1106, the object detection circuit processes the receive signal at a first receive chain coupled to the second antenna to generate a processed receive signal. In some aspects, processing the receive signal may include at least one of amplifying or phase shifting the receive signal. At block 1108, the object detection circuit uses a signal from a chain other than the first receive chain to at least partially cancel the mutual coupling component of the processed receive signal using an on-chip signal path. In some aspects, using the signal to at least partially cancel the mutual coupling component comprises phase shifting the signal.

In some aspects, the other chain may include a second receive chain coupled to a third antenna (e.g., antenna 502 of FIG. 5A). The other chain may be a second receive chain (e.g., receive chain including LNA 551 of FIG. 5B) coupled to the second antenna, and where the first receive chain and the second receive chain process different polarizations.

In some aspects, the other chain is a second transmit chain coupled to the second antenna. The other chain may be a second receive chain coupled to an unused antenna port. The second receive chain may be configured to process a signal from a second transmit chain coupled to the unused antenna port. The second receive chain may be configured to process a signal from the first transmit chain received over the on-chip signal path. In some aspects, the on-chip signal path may be configured to selectively couple to the first transmit chain and to selectively couple to the second receive chain. In some cases, the other chain is used for signal reception.

### Example Aspects

Aspect 1: A method for object detection by a device, comprising: transmitting, via a first antenna, a transmit signal generated via a first transmit chain of the device, the transmit signal being generated based on a mixer output signal; receiving a first receive signal via a first receive chain coupled to a second antenna of the device, the first receive signal being associated with the transmit signal; generating, via a first phase shifter of the device, a first phase-shifted signal based on an adjustment signal received via a signal path of the device coupled to the first transmit chain, the adjustment signal being generated based on the mixer output signal; and combining the first phase-shifted signal and the first receive signal to generate a combined receive signal, wherein a phase-shift setting of the first phase shifter is controlled based on at least one of a mutual coupling component or a phase noise of the combined receive signal.

Aspect 2: The method of Aspect 1, further comprising controlling an amplitude of at least one of the first phase-shifted signal or a second phase-shifted signal based on the adjustment signal.

Aspect 3: The method of Aspect 1 or 2, wherein the first phase shifter is part of a second receive chain of the device, and wherein the signal path is coupled between the first transmit chain and the second receive chain.

Aspect 4: The method of Aspect 3, wherein the second receive chain is coupled to an unused antenna port.

Aspect 5: The method according to any of Aspects 1-4, further comprising generating, via an amplifier of the first transmit chain, the transmit signal for transmission via the first antenna, the adjustment signal being received through a coupler coupled to an output of the amplifier of the first transmit chain.

Aspect 6: The method according to any of Aspects 1-5, wherein the signal path of the device comprises a second transmit chain of the device.

Aspect 7: The method of Aspect 6, further comprising generating the adjustment signal via a second phase shifter of the second transmit chain, wherein a phase-shift setting of the second phase shifter is controlled to reduce the at least one of the mutual coupling component or the phase noise of the combined receive signal.

Aspect 8: The method of Aspect 7, wherein the second transmit chain comprises an amplifier coupled to an output of the second phase shifter and wherein the amplifier is bypassed or configured in a low-gain mode while the adjustment signal is generated via the second phase shifter.

Aspect 9: The method according to any of Aspects 6-8, wherein the second transmit chain is coupled to the second antenna.

Aspect 10: The method of Aspect 9, further comprising: receiving a second receive signal via a third receive chain coupled to a third antenna of the device, the second receive signal being associated with the transmit signal; and generating, via a second phase shifter of the second transmit chain of the device, a second phase-shifted signal, wherein the combined receive signal is generated by combining the first phase-shifted signal, the first receive signal, and the second phase-shifted signal, and wherein a phase-shift setting of the second phase shifter is controlled based on the mutual coupling component or the phase noise of the combined receive signal.

Aspect 11: The method of Aspect 10, wherein the second transmit chain is coupled to the third antenna.

Aspect 12: The method according to any of Aspects 1-11, wherein the transmit signal comprises a frequency modulated continuous wave (FMCW) signal.

Aspect 13: The method according to any of Aspects 1-12, wherein the first receive signal includes a target reflection component associated with a reflection of the transmit signal from an object.

Aspect 14: The method according to any of Aspects 1-13, further comprising detecting a presence of an object based on the combined receive signal.

Aspect 15: The method of Aspect 14, wherein detecting the presence of the object comprises detecting a distance from the device to the object based on a frequency of the combined receive signal.

Aspect 16: The method according to any of Aspects 1-15, wherein the mutual coupling component is associated with a signal received by the second antenna directly from the first antenna.

Aspect 17: A device capable of object detection, comprising: a first transmit chain configured to transmit, via a first antenna, a transmit signal, the transmit signal being generated based on a mixer output signal; a first receive chain coupled to a second antenna and configured to receive a first receive signal, the first receive signal being associated with the transmit signal; a first phase shifter configured to generate a first phase-shifted signal based on an adjustment signal received via a signal path of the device coupled to the first transmit chain, the adjustment signal being generated based on the mixer output signal, wherein the first phase-shifted signal and the first receive signal are combined to generate a combined receive signal; and a control unit configured to control a phase-shift setting of the first phase shifter based on a mutual coupling component or a phase noise of the combined receive signal.

Aspect 18: The device of Aspect 17, further comprising a second receive chain comprising the first phase shifter, wherein the signal path is between the first transmit chain and the second receive chain.

Aspect 19: The device of Aspect 18, wherein the second receive chain is coupled to an unused antenna port.

Aspect 20: The device according to any of Aspects 17-19, wherein the first transmit chain comprises an amplifier configured to generate the transmit signal for transmission via the first antenna, the adjustment signal being received through a coupler coupled to an output of the amplifier of the first transmit chain.

Aspect 21: The device according to any of Aspects 17-20, wherein the signal path of the device comprises a second transmit chain of the device.

Aspect 22: The device of Aspect 21, wherein: the second transmit chain comprises a second phase shifter configured to generate the adjustment signal; and the control unit is configured to control a phase-shift setting of the second phase shifter to reduce the mutual coupling component or the phase noise of the combined receive signal.

Aspect 23: The device of Aspect 22, wherein the second transmit chain comprises an amplifier coupled to an output of the second phase shifter, wherein the amplifier is bypassed or configured in a low-gain mode while the adjustment signal is generated via the second phase shifter.

Aspect 24: The device according to any of Aspects 21-23, wherein the second transmit chain is coupled to the second antenna.

Aspect 25: The device of Aspect 24, further comprising: a third receive chain coupled to a third antenna of the device and configured to receive a second receive signal, the second receive signal being associated with the transmit signal, wherein: the second transmit chain comprising a second phase shifter configured to generate a second phase-shifted signal; the combined receive signal is generated by combining the first phase-shifted signal, the first receive signal, and the second phase-shifted signal; and the control unit is configured to control a phase-shift setting of the second phase shifter to reduce the mutual coupling component or the phase noise of the combined receive signal.

Aspect 26: The device of Aspect 25, wherein the second transmit chain is coupled to the third antenna.

Aspect 27: The device according to any of Aspects 17-26, wherein the transmit signal comprises a frequency modulated continuous wave (FMCW) signal.

Aspect 28: The device according to any of Aspects 17-27, wherein the first receive signal includes a target reflection component associated with a reflection of the transmit signal from an object.

Aspect 29: The device according to any of Aspects 17-28, further comprising one or more processors configured to detect an object based on the combined receive signal.

Aspect 30: An apparatus for object detection by a device, comprising: means for transmitting a transmit signal, the transmit signal being generated based on a mixer output signal; means for receiving a first receive signal, the first receive signal being associated with the transmit signal; means for generating a first phase-shifted signal based on an adjustment signal received via a signal path of the device, the adjustment signal being generated based on the mixer output signal, wherein the first phase-shifted signal and the first receive signal are combined to generate a combined receive signal; and means for controlling a phase-shift setting associated with the means for generating based on a mutual coupling component or a phase noise of the combined receive signal.

### Additional Considerations

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another-even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

For example, means for transmitting may include a transmit chain, such as the transmit chain including PA 314 and antenna 402. Means for receiving a first receive signal may include a receive chain, such as the receive chain including antenna 404 or antenna 502. Means for generating may include a phase shifter such as the phase shifter 550 or phase shifter 552. Means for combining may include a combiner such as the combiner 554. Means for controlling may include a control unit, such as the control unit 574.

It is to be understood that the claims are not limited to the precise configuration and components illustrated above. Various modifications, changes and variations may be made in the arrangement, operation and details of the methods and apparatus described above without departing from the scope of the claims.

1. A method for object detection by a device, comprising:
transmitting, via a first antenna, a transmit signal generated via a first transmit chain of the device, the transmit signal being generated based on a mixer output signal;
receiving a first receive signal via a first receive chain coupled to a second antenna of the device, the first receive signal being associated with the transmit signal;
generating, via a first phase shifter of the device, a first phase-shifted signal based on an adjustment signal received via a signal path of the device coupled to the first transmit chain, the adjustment signal being generated based on the mixer output signal; and
combining the first phase-shifted signal and the first receive signal to generate a combined receive signal, wherein a phase-shift setting of the first phase shifter is controlled based on at least one of a mutual coupling component or a phase noise of the combined receive signal.

2. The method of claim 1, further comprising controlling an amplitude of at least one of the first phase-shifted signal or a second phase-shifted signal based on the adjustment signal.

3. The method of claim 1, wherein the first phase shifter is part of a second receive chain of the device, and wherein the signal path is coupled between the first transmit chain and the second receive chain.

4. The method of claim 3, wherein the second receive chain is coupled to an unused antenna port.

5. The method of claim 1, further comprising generating, via an amplifier of the first transmit chain, the transmit signal for transmission via the first antenna, the adjustment signal being received through a coupler coupled to an output of the amplifier of the first transmit chain.

6. The method of claim 1, wherein the signal path of the device comprises a second transmit chain of the device.

7. The method of claim 6, further comprising generating the adjustment signal via a second phase shifter of the second transmit chain, wherein a phase-shift setting of the second phase shifter is controlled to reduce the at least one of the mutual coupling component or the phase noise of the combined receive signal.

8. The method of claim 7, wherein the second transmit chain comprises an amplifier coupled to an output of the second phase shifter and wherein the amplifier is bypassed or configured in a low-gain mode while the adjustment signal is generated via the second phase shifter.

9. The method of claim 6, wherein the second transmit chain is coupled to the second antenna.

10. The method of claim 9, further comprising:
receiving a second receive signal via a third receive chain coupled to a third antenna of the device, the second receive signal being associated with the transmit signal; and
generating, via a second phase shifter of the second transmit chain of the device, a second phase-shifted signal, wherein the combined receive signal is generated by combining the first phase-shifted signal, the first receive signal, and the second phase-shifted signal, and wherein a phase-shift setting of the second phase shifter is controlled based on the mutual coupling component or the phase noise of the combined receive signal.

11. The method of claim 10, wherein the second transmit chain is coupled to the third antenna.

12. The method of claim 1, wherein the transmit signal comprises a frequency modulated continuous wave (FMCW) signal.

13. The method of claim 1, wherein the first receive signal includes a target reflection component associated with a reflection of the transmit signal from an object.

14. The method of claim 1, further comprising detecting a presence of an object based on the combined receive signal.

15. The method of claim 14, wherein detecting the presence of the object comprises detecting a distance from the device to the object based on a frequency of the combined receive signal.

16. The method of claim 1, wherein the mutual coupling component is associated with a signal received by the second antenna directly from the first antenna.

17. A device capable of object detection, comprising:
a first transmit chain configured to transmit, via a first antenna, a transmit signal, the transmit signal being generated based on a mixer output signal;
a first receive chain coupled to a second antenna and configured to receive a first receive signal, the first receive signal being associated with the transmit signal;
a first phase shifter configured to generate a first phase-shifted signal based on an adjustment signal received via a signal path of the device coupled to the first transmit chain, the adjustment signal being generated based on the mixer output signal, wherein the first phase-shifted signal and the first receive signal are combined to generate a combined receive signal; and
a control unit configured to control a phase-shift setting of the first phase shifter based on a mutual coupling component or a phase noise of the combined receive signal.

18. The device of claim 17, further comprising a second receive chain comprising the first phase shifter, wherein the signal path is between the first transmit chain and the second receive chain.

19. The device of claim 18, wherein the second receive chain is coupled to an unused antenna port.

20. The device of claim 17, wherein the first transmit chain comprises an amplifier configured to generate the transmit signal for transmission via the first antenna, the adjustment signal being received through a coupler coupled to an output of the amplifier of the first transmit chain.

21. The device of claim 17, wherein the signal path of the device comprises a second transmit chain of the device.

22. The device of claim 21, wherein:
the second transmit chain comprises a second phase shifter configured to generate the adjustment signal; and
the control unit is configured to control a phase-shift setting of the second phase shifter to reduce the mutual coupling component or the phase noise of the combined receive signal.

23. The device of claim 22, wherein the second transmit chain comprises an amplifier coupled to an output of the second phase shifter, wherein the amplifier is bypassed or configured in a low-gain mode while the adjustment signal is generated via the second phase shifter.

24. The device of claim 21, wherein the second transmit chain is coupled to the second antenna.

25. The device of claim 24, further comprising:
a third receive chain coupled to a third antenna of the device and configured to receive a second receive signal, the second receive signal being associated with the transmit signal, wherein:
the second transmit chain comprising a second phase shifter configured to generate a second phase-shifted signal;
the combined receive signal is generated by combining the first phase-shifted signal, the first receive signal, and the second phase-shifted signal; and
the control unit is configured to control a phase-shift setting of the second phase shifter to reduce the mutual coupling component or the phase noise of the combined receive signal.

26. The device of claim 25, wherein the second transmit chain is coupled to the third antenna.

27. The device of claim 17, wherein the transmit signal comprises a frequency modulated continuous wave (FMCW) signal.

28. The device of claim 17, wherein the first receive signal includes a target reflection component associated with a reflection of the transmit signal from an object.

29. The device of claim 17, further comprising one or more processors configured to detect an object based on the combined receive signal.

30. An apparatus for object detection by a device, comprising:
means for transmitting a transmit signal, the transmit signal being generated based on a mixer output signal;
means for receiving a first receive signal, the first receive signal being associated with the transmit signal;
means for generating a first phase-shifted signal based on an adjustment signal received via a signal path of the device, the adjustment signal being generated based on the mixer output signal, wherein the first phase-shifted signal and the first receive signal are combined to generate a combined receive signal; and
means for controlling a phase-shift setting associated with the means for generating based on a mutual coupling component or a phase noise of the combined receive signal.
